(19) United States
(12) Patent Application Publication
(10) Pub. No.: US 2022/0293096 A1
(43) Pub. Date: Sep. 15, 2022

(54) USER-ORIENTED ACTIONS BASED ON AUDIO CONVERSATION

(71) Applicant: SONY GROUP CORPORATION, TOKYO (JP)

(72) Inventors: BIBHUDENDU MOHAPATRA, SAN DIEGO, CA (US); WILLIAM CLAY, SAN DIEGO, CA (US)

(21) Appl. No.: 17/195,923

(22) Filed: Mar. 9, 2021

(51) Int. Cl. G10L 15/22; G06F 40/279; G06F 3/14; G10L 15/08; G10L 15/06; G06F 3/16; G06N 20/00

(52) U.S. Cl. CPC G10L 15/22; G06F 40/279; G06F 3/14; G10L 15/08; G10L 15/063; G06F 3/167; G06N 20/00; G10L 2015/223; G10L 2015/228; G10L 2015/227; G10L 2015/088

(57) ABSTRACT

An electronic device and method for information extraction and user-oriented actions based on audio conversation are provided. The electronic device receives an audio signal that corresponds to a conversation associated with a first user and a second user. The electronic device extracts text information from the received audio signal based on at least one extraction criteria. The electronic device applies a machine learning model on the extracted text information to identify at least one type of information of the extracted text information. The electronic device determines a set of applications associated with the electronic device based on the identified at least one type of information. The electronic device selects a first application from the determined set of applications based on at least one selection criteria, and controls execution of the selected first application based on the text information.

### CROSS-REFERENCE TO RELATED APPLICATIONS/INCORPORATION BY REFERENCE

None.

### FIELD

Various embodiments of the disclosure relate to information extraction and user-oriented actions. More specifically, various embodiments of the disclosure relate to an electronic device and method for information extraction and user-oriented actions based on audio conversation.

### BACKGROUND

Recent advancements in the field of information processing have led to development of various technologies to process audio (such as audio-to-text conversion) using an electronic device (for example, a mobile phone, a smart phone, and other electronic devices). Typically, when a user of the electronic device is in conversation (e.g. a phone call) with another user, the user may need to write down or save a piece of relevant information (such as a name, telephone number, address, etc.) during the ongoing conversation. However, this may be highly inconvenient in case the user holds the conversation while performing another action (such as walking or driving, etc.). In certain situations, the user may also miss a part of the conversation while searching for a pen and/or paper. In certain other situations, the user may manually enter the information into the electronic device by putting the conversation on speaker, which may be inconvenient and may raise privacy concerns. In other situations, even if the user has managed to save the information, there may be other pieces of unsaved information spoken during the conversation that may be relevant to the user or associated with the saved information.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for information extraction and user-oriented action based on audio conversation is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for information extraction and user-oriented actions based on audio conversation, in accordance with an embodiment of the disclosure.

FIG. 2 is a block diagram that illustrates an exemplary electronic device for information extraction and user-oriented actions based on audio conversation, in accordance with an embodiment of the disclosure.

FIG. 3 is a diagram that illustrates exemplary operations performed by an electronic device for information extraction and user-oriented actions based on audio conversation, in accordance with an embodiment of the disclosure.

FIG. 4A is a diagram that illustrates an exemplary first user interface (UI) that may display output information, in accordance with an embodiment of the disclosure.

FIG. 4B is a diagram that illustrates an exemplary second user interface (UI) that may display output information, in accordance with an embodiment of the disclosure.

FIG. 4C is a diagram that illustrates an exemplary third user interface (UI) that may display output information, in accordance with an embodiment of the disclosure.

FIG. 4D is a diagram that illustrates an exemplary fourth user interface (UI) that may display output information, in accordance with an embodiment of the disclosure.

FIG. 4E is diagram that illustrates an exemplary fifth user interface (UI) that may display output information, in accordance with an embodiment of the disclosure.

FIG. 5 is a diagram that illustrates an exemplary user interface (UI) that may recognize verbal cues as trigger to capture audio signals, in accordance with an embodiment of the disclosure.

FIG. 6 is a diagram that illustrates an exemplary user interface (UI) that may receive user input as trigger to capture audio signals, in accordance with an embodiment of the disclosure.

FIG. 7 is a diagram that illustrates an exemplary user interface (UI) that may search extracted text information based on user input, in accordance with an embodiment of the disclosure.

FIG. 8 is a diagram that illustrates exemplary operations for training a machine learning (ML) model employed for information extraction and user-oriented actions based on audio conversation, in accordance with an embodiment of the disclosure.

FIG. 9 depicts a flowchart that illustrates an exemplary method for information extraction and user-oriented actions based on audio conversation, in accordance with an embodiment of the disclosure.

### DETAILED DESCRIPTION

The following described implementations may be found in the disclosed electronic device and method for automatic information extraction from audio conversation. Exemplary aspects of the disclosure provide an electronic device (for example, a mobile phone, a smart phone, or other electronic device) which may be configured execute an audio only call or an audio-video call for a conversation between a first user and a second user. The electronic device may receive an audio signal that corresponds to the conversation, and may extract text information from the received audio signal based on at least one extraction criteria. Examples of the at least one extraction criteria may include, but are not limited to, a user profile (such as gender, hobbies or interests, profession, frequently visited places, frequently purchased products or services, etc.) associated with the first user, a user profile associated with the second user in the conversation with the first user, a geo-location location of the first user, or a current time. For example, the audio signal may include a recorded message or a real-time conversation between the first user and the second user. The extracted text information may include a particular type of information relevant to the first user. The electronic device may apply a machine learning model on the extracted text information to identify at least one type of information of the extracted text information. For example, the type of information may include, but is not limited to, a location, a phone number, a name, a date, a time schedule, a landmark, a unique identifier, or a universal resource locator. The electronic device may further determine a set of applications (for example, but not limited to, a phone book, a calendar application, an internet browser, a text editor application, a map application, an e-commerce application, or an application related to a service provider) associated with the electronic device based on the identified at least one type of information.

The electronic device may select a first application from the determined set of applications based on at least one selection criteria. Examples of the at least one selection criteria may include, but are not limited to, a user profile associated with the first user, a user profile associated with the second user, a relationship between the first user and the second user, a context of the conversation, a capability of the electronic device to execute the set of applications, a priority of each application of the set of applications, a frequency of selection of each application of the set of applications, usage information corresponding to the set of applications, current news, current time, a geo-location of the first user, a weather forecast, or a state of the first user. The electronic device may further control execution of the first application based on the extracted text information, and may control display of output information (such as a notification of a task based on the conversation, a notification of a new contact added to a phonebook, or a notification of a reminder added to a calendar application, a navigational map, a website, a searched product or service, a user interface of the first application, etc.) based on the execution of the first application. Thus, the disclosed electronic device may dynamically extract relevant information (i.e. text information) from the conversation, and improve user convenience by extraction of the relevant information (such as names, telephone numbers, addresses, or any other information) from the conversation in real time. The disclosed electronic device may further enhance user experience based on intelligent selection and execution of an application to use the extracted information to perform a relevant action (such as save a phone number, set a reminder, open a website, open a navigational map, search a product or service, etc.), and display the output information in a convenient ready-to-use manner.

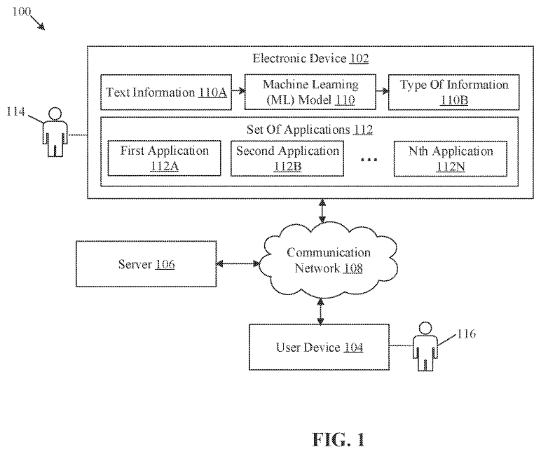

FIG. 1 is a block diagram that illustrates an exemplary network environment for information extraction and user-oriented actions based on audio conversation, in accordance with an embodiment of the disclosure. With reference to FIG. 1, there is shown a network environment 100. In the network environment 100, there is shown an electronic device 102, a user device 104, and a server 106, which may be communicatively coupled with each other via a communication network 108. The electronic device 102 may include a machine learning (ML) model 110 which may process the text information 110A to provide type of information 110B. The electronic device 102 may further include a set of applications 112. In the network environment 100, there is further shown a first user 114 who may be associated with the electronic device 102, and a second user 116 who may be associated with the user device 104. The set of applications 112 may include a first application 112A, a second application 1128, and so on up to an Nth application 112N. It may be noted that the first application 112A, the second application 112B, and the Nth application 112N shown in FIG. 1 are presented merely as an example. The set of applications 112 may include only one application or more than one application, without deviating from the scope of the disclosure. It may be noted that the conversation between the first user 114 and the second user 116 is presented merely as an example. The network environment may include multiple users carrying out a conversation (e.g. through a conference call), or may include a conversation between the first user 114 and a machine (such as an AI assistant), a conversation between two or more machines (such as between two or more IoT devices, or V2X communications), or any combination thereof, without deviating from the scope of the disclosure.

The electronic device 102 may include suitable logic, circuitry, and/or interfaces that may be configured to execute or process an audio only call or an audio-video call, and may include an operating environment to host the set of applications 112. The electronic device 102 may be configured to receive an audio signal that corresponds to a conversation associated with or between the first user 114 and the second user 116. The electronic device 102 may be configured to extract the text information 110A from the received audio signal based on at least one extraction criteria. The electronic device 102 may be configured to select the first application 112A based on at least one selection criteria. The electronic device 102 may be configured to control execution of the selected first application 112A based on the text information 110A. The electronic device 102 may include an application (downloadable from the server 106) to manage the extraction of the text information 110A, selection of the first application 112A, reception of user input, and display of the output information. Examples of the electronic device 102 may include, but are not limited to, a mobile phone, a smart phone, a tablet computing device, a personal computer, a gaming console, a media player, a smart audio device, a video conferencing device, a server, or other consumer electronic device with communication and information processing capability.

The user device 104 may include suitable logic, circuitry, and interfaces that may be configured to communicate (for example via audio or audio-video calls) with the electronic device 102, via the communication network 108. The user device 104 may be a consumer electronic device associated with the second user 116, and may include, for example, a mobile phone, a smart phone, a tablet computing device, a personal computer, a gaming console, a media player, a smart audio device, a video conferencing device, or other consumer electronic device with communication capability.

The server 106 may include suitable logic, circuitry, and interfaces that may be configured to store a centralized machine learning (ML) model. In some embodiments, the server 106 may be configured to train the ML model and distribute copies of the ML model (such as the ML model 110) to end user devices (such as electronic device 102). The server 106 may provide a downloadable application to the electronic device 102 to manage the extraction of the text information 110A, selection of the first application 112A, reception of the user input, and the display of the output information. In certain instances, the server 106 may be implemented as a cloud server which may execute operations through web applications, cloud applications, HTTP requests, repository operations, file transfer, and the like. Other example implementations of the server 106 may include, but are not limited to, a database server, a file server, a web server, a media server, an application server, a mainframe server, or other types of servers. In certain embodiments, the server 106 may be implemented as a plurality of distributed cloud-based resources by use of several technologies that are well known to those skilled in the art. A person with ordinary skill in the art will understand that the scope of the disclosure may not be limited to implementation of the server 106 and the electronic device 102 as separate entities. Therefore, in certain embodiments, functionalities of the server 106 may be incorporated in its entirety or at least partially in the electronic device 102, without departing from the scope of the disclosure.

The communication network 108 may include a communication medium through which the electronic device 102, the user device 104, and/or the server 106 may communicate with each other. The communication network 108 may be a wired or wireless communication network. Examples of the communication network 108 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity(Li-Fi), 802.16, IEEE 802.11s, IEEE 802.11g, multi-hop communication, wireless access point (AP), device to device communication, cellular communication protocols, and Bluetooth (BT) communication protocols.

The ML model 110 may be a type identification model, which may be trained on a type identification task or a classification task of at least one type of information. The ML model 110 may be pre-trained on a training dataset of different information types typically present in the conversation (or in text information 110A). The ML model 110 may be defined by its hyper-parameters, for example, activation function(s), number of weights, cost function, regularization function, input size, number of layers, and the like. The hyper-parameters of the ML model 110 may be tuned and weights may be updated before or while training the ML model 110 on the training dataset so as to identify a relationship between inputs, such as features in a training dataset and output labels, such as different type of information e.g., a location, a phone number, a name, an identifier, or a date. After several epochs of the training on the feature information in the training dataset, the ML model 110 may be trained to output a prediction/classification result for a set of inputs (such as the text information 110A). The prediction result may be indicative of a class label (i.e. type of information) for each input of the set of inputs (e.g., input features extracted from new/unseen instances). For example, the ML model 110 may be trained on several training text information 110A to predict result, such as the type of information 110B of the extracted text information 110A. In some embodiments, the ML model 110 may be also trained or re-trained on determination of a set of applications 112 based on either the identified type of information 110B or a history of user selection of application for each type of information.

In an embodiment, the ML model 110 may include electronic data, which may be implemented as, for example, a software component of an application executable on the electronic device 102. The ML model 110 may rely on libraries, external scripts, or other logic/instructions for execution by a processing device, such as the electronic device 102. The ML model 110 may include computer-executable codes or routines to enable a computing device, such as the electronic device 102 to perform one or more operations to detect type of information of the extracted text information. Additionally, or alternatively, the ML model 110 may be implemented using hardware including a processor, a microprocessor (e.g., to perform or control performance of one or more operations), a field-programmable gate array (FPGA), or an application-specific integrated circuit (ASIC). For example, an inference accelerator chip may be included in the electronic device 102 to accelerate computations of the ML model 110 for the identification task. In some embodiments, the ML model 110 may be implemented using a combination of both hardware and software. Examples of the ML model 110 may include, but are not limited to, a neural network model or a model based on one or more of regression method(s), instance-based method(s), regularization method(s), decision tree method(s), Bayesian method(s), clustering method(s), association rule learning, and dimensionality reduction method(s).

Examples of the ML model 110 may include a neural network model, such as, but are not limited to, a deep neural network (DNN), a recurrent neural network (RNN), an artificial neural network (ANN), (You Only Look Once) YOLO network, a Long Short Term Memory (LSTM) network based RNN, CNN+ANN, LSTM+ANN, a gated recurrent unit (GRU)-based RNN, a fully connected neural network, a Connectionist Temporal Classification (CTC) based RNN, a deep Bayesian neural network, a Generative Adversarial Network (GAN), and/or a combination of such networks. In some embodiments, the ML model 110 may include numerical computation techniques using data flow graphs. In certain embodiments, the ML model 110 may be based on a hybrid architecture of multiple Deep Neural Networks (DNNs).

The set of applications 112 may include suitable logic, code, and/or interfaces that may execute on the operating system of the electronic device based on the text information 110A. Each application of the set of applications 112 may include program or set of instructions configured to perform a particular action based on the text information 110A. Examples of the set of applications 112 may include, but are not limited to, a calendar application, a phonebook application, a map application, a notes application, a text editor application, an e-commerce application (such as a shopping application, a food ordering application, a ticketing application, etc.), a mobile banking application, an e-learning application, an e-wallet application, an instant messaging application, an email application, a browser application, an enterprise application, a cab aggregator application, a translator application, any other applications installed on the electronic device 102, or a cloud-based application accessible via the electronic device 102. In an example, the first application 112A may correspond to the calendar application, and the second application 1128 may correspond to the phonebook application.

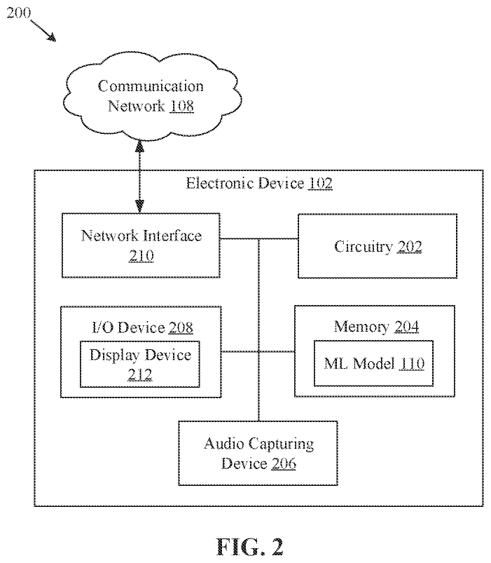

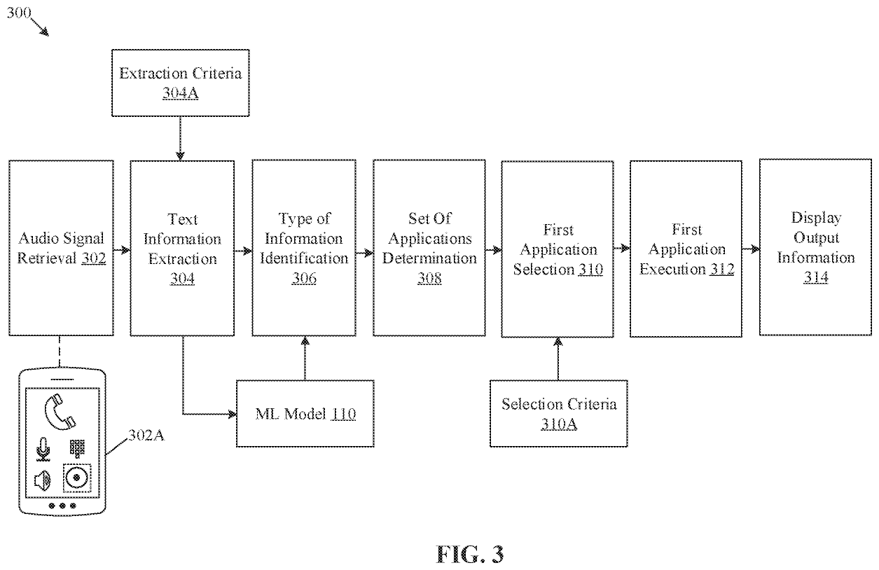

In operation, the electronic device 102 may be configured to receive or recognize a trigger (such as a user input or a verbal cue) to capture the audio signal associated with the conversation between the first user 114 and the second user 116 using an audio capturing device 206 (as described in FIG. 2). For example, the audio signal may include a recorded message or a real-time conversation between the first user 114 and the second user 116. The electronic device 102 may be configured to receive or retrieve the audio signal that corresponds to the conversation between the first user 114 and the second user 116. The electronic device 102 may be configured to extract the text information 110A from the received audio signal based on at least one extraction criteria, as described for example, in FIG. 3. Examples of the at least one extraction criteria may include, but are not limited to, a user profile associated with the first user 114, a user profile associated with the second user 116 in the conversation with the first user 114, a geo-location location of the first user 114, a current time, etc. The electronic device 102 may be configured to generate text information corresponding to the received audio signal using various speech-to-text conversion techniques and natural language processing (NLP) techniques. For example, the electronic device 102 may employ speech-to-text conversion techniques to convert the received audio signal into raw text, and then employ NLP techniques to extract the text information 110A (such as a name, phone number, address, etc.) from the raw text. The speech-to-text conversion techniques may correspond to a technique associated with analysis of the received audio signal (such as, a speech signal) in the conversation, and conversion of the received audio signal into the raw text. Examples of the NLP techniques associated with analysis of the raw text and/or the audio signal may include, but are not limited to, an automatic summarization, a sentiment analysis, a context extraction, a parts-of-speech tagging, a semantic relationship extraction, a stemming, a text mining, and a machine translation.

The electronic device 102 may be configured to apply the ML model 110 on the extracted text information 110A to identify at least one type of information 110B of the extracted text information 110A. The at least one type of information 110B may include, but are not limited to, a location, a phone number, a name, a date, a time schedule, a landmark, a unique identifier, or a universal resource locator. The ML model 110 used for the identification of the type of the information 110B may be same or different from that used for the extraction of the text information 110A. The ML model 110 may be pre-trained on a training dataset of different types of information 1108 typically present in any conversation. Details of the application of the ML model to identify the type of information 110B as described for example, in FIG. 3. Thus, the disclosed electronic device 102 may provide automatic extraction of the text information 110A from the conversation and identification of the type of information in real-time. Therefore, the disclosed electronic device 102 reduces time consumption and difficulty faced by the first user 114 in order to write down or save some information (such as names, telephone numbers, addresses, or any other information) during the conversation. As a result, the first user 114 may not miss any important or relevant part of the conversation.

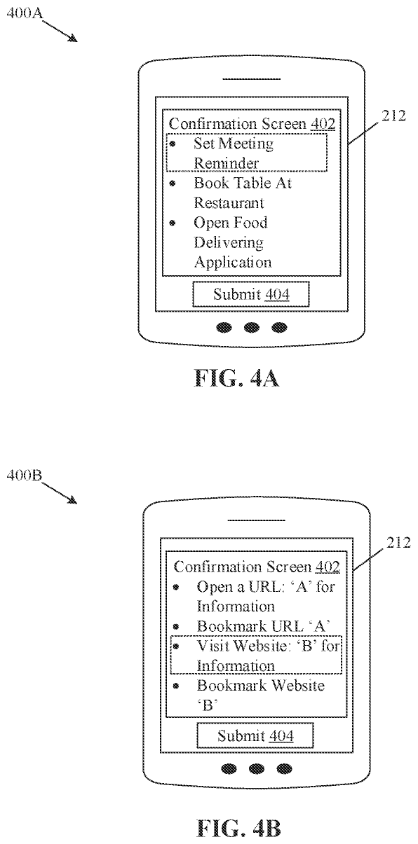

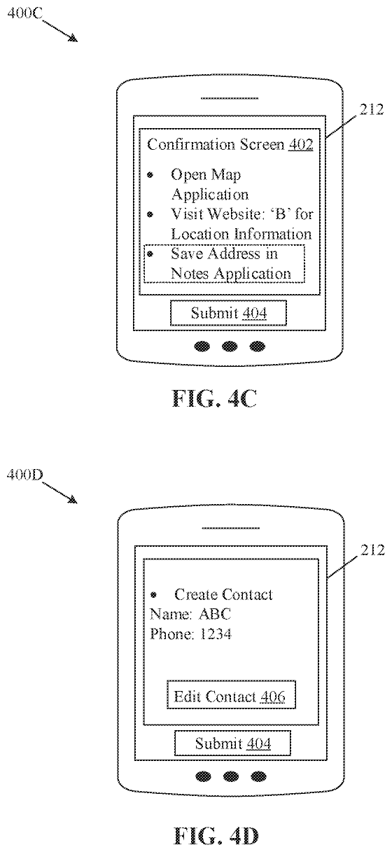

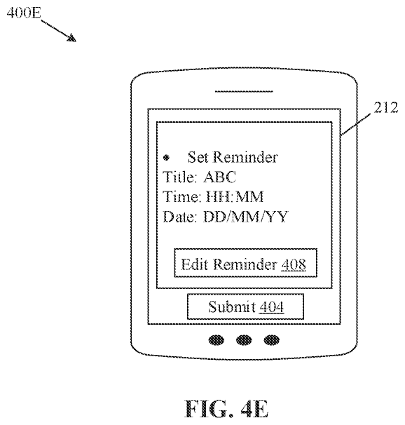

The electronic device 102 may be further configured to determine the set of applications 112 associated with the electronic device 102 based on the identified type of information 110B as described, for example, in FIGS. 4A-4E. Based on at least one selection criteria, the electronic device 102 may be configured to select the first application 112A from the determined set of applications 112 as described, for example, in FIG. 3. Examples of the at least one selection criteria may include, but are not limited to, a user profile associated with the first user 114, a user profile associated with the second user 116, a relationship between the first user 114 and the second user 116, a context of the conversation, a capability of the electronic device 102 to execute the set of applications 112, a priority of each application of the set of applications 112, a frequency of selection of each application of the set of applications 112, usage information corresponding to the set of applications 112, current news, current time, a geo-location of the first user 114, a weather forecast, or a state of the first user 114.

The electronic device 102 may be further configured to control execution of the selected first application 112A based on the text information 110A as described, for example, in FIGS. 3 and 4A-4E. The disclosed electronic device 102 may provide automatic control of the execution of the selected first application 112A to display output information. Examples of the output information may include, but are not limited to at least one of a set of instructions to execute a task, a uniform resource locator (URL) related to the text information 110A, a website related to the text information 110A, a keyword in the text information 110A, a notification of the task based on the conversation, a notification of a new contact added to a phonebook as the first application 112A, a notification of a reminder added to a calendar application as the first application 112A, or a user interface of the first application 112A. Thus, the electronic device 102 may enhance the user experience by intelligent selection and execution of the first application 112A (such as a phonebook application, a calendar application, a browser, a navigation application, an e-commerce application, or other relevant application, etc.) to use the extracted text information 110A to perform a relevant action (such as save a phone number, set a reminder, open a website, open a navigational map, search a product or service, etc.), and display of the output information in a convenient ready-to-use manner. Details of different actions performed by one or more applications based on the extracted text information 110A are provided, for example, in FIGS. 4A-4E.

In an embodiment, the electronic device 102 may be configured to determine the context of the conversation based on a user profile of the second user 116 in the conversation with the first user 114, a relationship of the first user 114 and the second user 116, a profession of each of the first user 114 and the second user 116, a frequency of the conversation of the first user 114 with the second user 116, or a time of the conversation. In certain embodiments, the electronic device 102 may be configured to change the priority associated with each application of the set of applications 112 based on a relationship of the first user 114 and the second user 116.

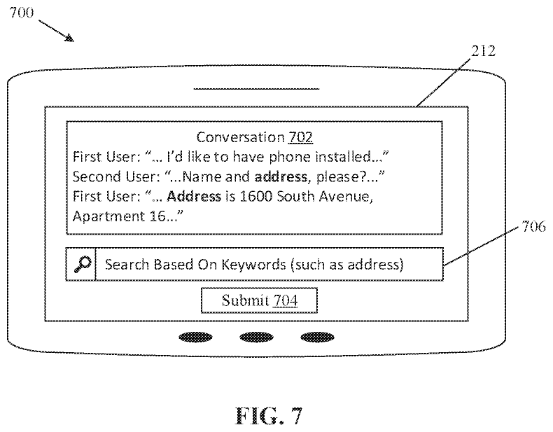

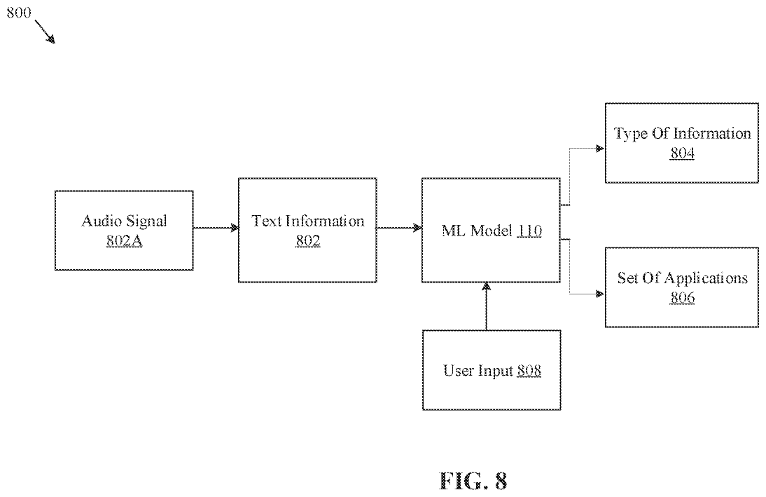

In an embodiment, the electronic device 102 may be configured to select the first application 112A based on user input. and train or re-train the ML model 110 based on the selected first application 112A as described, for example, in FIGS. 4A-4C. In another embodiment, the electronic device may be configured to search the extracted text information based on user input, and control display of a result of the search. The electronic device 102 may be further configured to train the ML model 110 to identify the at least one type of information based on a type of the result as described, for example, in FIG. 7.

FIG. 2 is a block diagram that illustrates an exemplary electronic device of FIG. 1 for information extraction and user-oriented actions based on audio conversation, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202. The electronic device 102 may further include a memory 204, an audio capturing device 206, and an I/O device 208. The I/O device 208 may further include a display device 212. Further, the electronic device 102 may include a network interface 210, through which the electronic device 102 may be connected to the communication network 108. The memory 204 may store the trained ML model 110 and associated training data.

The circuitry 202 may include suitable logic, circuitry, interfaces, and/or code that may be configured to execute program instructions associated with different operations to be executed by the electronic device 102. For example, some of the operations may include reception of the audio signal, extraction of the text information 110A, application of the ML model 110 on the extracted text information 110A, identification of the type of text information 110A, determination of the set of applications 112, selection of the first application 112A, and the control execution of the selected first application 112A. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store the one or more instructions to be executed by the circuitry 202. The memory 204 may be configured to store the audio signal, the extracted text information 110A, the type of information 110B, and the output information. In some embodiments, the memory 204 may be configured to host the ML model 110 to identify the type of information 110B and select the set of applications 112. The memory 204 may be further configured to store application data and user data associated with the set of applications 112. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The audio capturing device 206 may include suitable logic, circuitry, code and/or interfaces that may be configured to capture the audio signal that corresponds to the conversation between the first user 114 and the second user 116. Examples of the audio capturing device 206 may include, but are not limited to, a recorder, an electret microphone, a dynamic microphone, a carbon microphone, a piezoelectric microphone, a fiber microphone, a micro-electro-mechanical-systems (MEMS) microphone, or other microphones

The I/O device 208 may include suitable logic, circuitry, interfaces, and/or code that may be configured to receive an input and provide an output based on the received input. The I/O device 208 may include various input and output devices, which may be configured to communicate with the circuitry 202. For example, the electronic device 102 may receive a user input via the I/O device 208 to trigger capture of the audio signal associated with the conversation, select of the first application 112A, and to search the extracted text information 110A. Further, the electronic device 102 may control the I/O device 208 to render the output information. Examples of the I/O device 208 may include, but are not limited to, a touch screen, a keyboard, a mouse, a joystick, a display device (for example, the display device 212), a microphone, or a speaker.

The display device 212 may include suitable logic, circuitry, and/or interfaces that may be configured to display the output information of the first application 112A. In one embodiment, the display device 212 may be a touch-enabled device which may enable the display device 212 to receive a user input by touch. The display device 212 may include a display unit that may be realized through several known technologies such as, but not limited to, at least one of a Liquid Crystal Display (LCD) display, a Light Emitting Diode (LED) display, a plasma display, or an Organic LED (OLED) display technology, or other display technologies.

The network interface 210 may comprise suitable logic, circuitry, interfaces, and/or code that may be configured to facilitate communication between the electronic device 102, the user device 104, and the server 106, via the communication network 108. The network interface 210 may be implemented by use of various known technologies to support wired or wireless communication of the electronic device 102 with the communication network 108. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 210 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX).

A person of ordinary skill in the art will understand that the electronic device 102 in FIG. 2 may also include other suitable components or systems, in addition to the components or systems which are illustrated herein to describe and explain the function and operation of the present disclosure. A detailed description for the other components or systems of the electronic device 102 has been omitted from the disclosure for the sake of brevity. The operations of the circuitry 202 are further described, for example, in FIGS. 3, 4A-4E, 5, 6, 7, 8, and 9.

FIG. 3 is a diagram that illustrates exemplary operations performed by an electronic device for information extraction and user-oriented actions based on audio conversation, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 314, as described herein. The exemplary operations illustrated in block diagram 300 may start at 302 and may be performed by any computing system, apparatus, or device, such as by the electronic device 102 of FIG. 1 or the circuitry 202 of FIG. 2. With reference to FIG. 3, there is further shown an electronic device 302A. The configuration and functionalities of the electronic device 302A may be same as the configuration and functionalities of the electronic device 102 described, for example, in FIG. 1. Therefore, the description of the electronic device 302A is omitted from the disclosure for the sake of brevity.

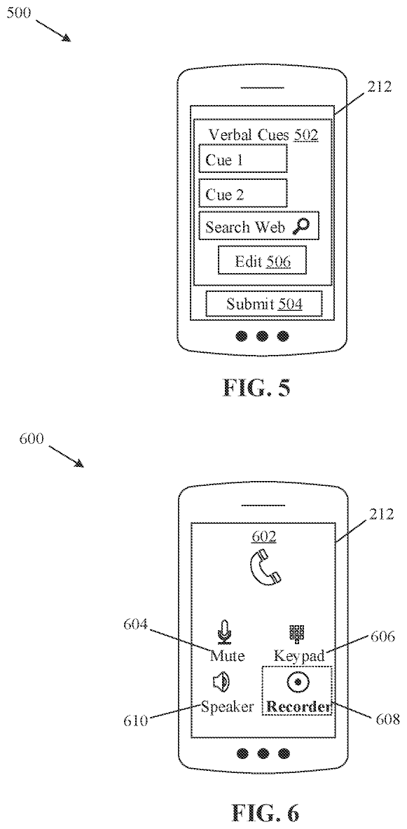

At 302, an audio signal may be received. The circuitry 202 may receive the audio signal that corresponds to a conversation between a first user (such as the first user 114) and a second user (such as the second user 116). The first user 114 and the second user 116 may correspond to a receiving end (such as a callee) or a transmitting end (such as a caller), respectively, in the conversation. The audio signal may include at least one of a recorded message or a real-time conversation between the first user 114 and the second user 116. In an embodiment, the circuitry 202 may control an audio capturing device (such as the audio capturing device 206) to capture the audio signal based on a trigger (such as a verbal cue or a user input, as described, for example, in FIGS. 5 and 6. The circuitry 202 may receive the audio signal from a data source. The data source may be for example, the audio capturing device 206, a memory (such as the memory 204) on the electronic device 302A, a cloud server (such as the server 106), or a combination thereof. The received audio signal may include audio information (for example, an audio portion) associated with the conversation.

In an embodiment, the circuitry 202 may be configured to convert the received audio signal into raw text using various speech-to-text conversion techniques. The circuitry 202 may be configured to use NLP techniques to extract the text information 110A (such as, a name, a phone number, an address, a unique identifier, a time schedule, etc.) from the raw text. In some embodiments, the circuitry 202 may be configured to concurrently execute speech-to-text conversion and NLP techniques to extract the text information 110A from the audio signal. In another embodiment, the circuitry 202 may be configured to execute NLP directly on the received audio signal and generate the text information 110A from the received audio signal. The detailed implementation of the aforementioned NLP techniques may be known to one skilled in the art, and therefore, a detailed description for the aforementioned NLP techniques has been omitted from the disclosure for the sake of brevity.

At 304, text information (such as the text information 110A) may be extracted. The circuitry 202 may extract the text information 110A from the received audio signal (or from textual form of the audio signal) based on at least one extraction criteria 304A. The extracted text information 110A may correspond to a particular text information extracted from the conversation, such that the text information 110A may include information relevant or important to the first user 114. Such extracted text information 110A may correspond to the information that the first user 114 may desire to store during the conversation for example, a phone number, a name, a date, an address, and the like. In an embodiment, the circuitry 202 may be configured to extract the text information 110A automatically during a real-time conversation between the first user 114 and the second user 116. In another embodiment, the circuitry 202 may be configured to extract the text information 110A from a recorded message associated with the conversation between the first user 114 and the second user 116. For example, the circuitry 202 may be configured to convert the received audio signal into raw text using speech-to-text conversion techniques. The circuitry 202 may be configured to use NLP techniques to extract the text information 110A (such as, a name, a phone number, an address, a unique identifier, a time schedule, etc.) from the raw text. In an embodiment, the text information 110A may be a word or a phrase (including multiple words) extracted from the audio signal related to the conversation or extracted from a textual representation of the conversation (either a recorded or an ongoing call).

Examples of the at least one extraction criteria 304A may include, but not limited to, a user profile associated with the first user 114, a user profile associated with the second user 116 in the conversation with the first user 114, a relationship of the first user 114 and the second user 116, a profession of each of the first user 114 and the second user 116, a location, or a time of the conversation. The user profile of the first user 114 may correspond to one of interests or preferences associated with the first user 114, and the user profile of the second user 116 may correspond to one of interests or preferences associated with the second user 116. For example, the user profile may include, but is not limited to, a name, age, gender, domicile location, time of day preferences, hobbies, profession, frequently visited places, frequently purchased products or services, or other preferences associated with given user (such as the first user 114, or the second user 116). Examples of the relationship of the first user 114 and the second user 116 may include, but not limited to, a professional relationship (such as, colleague, client, etc.), personal relationship (for example, parents, children, spouse, friends, neighbors, etc.), or any other relationship (for example, bank relationship manager, restaurant delivery, gym trainer, etc.).

In an example, the profession of each of the first user 114 and the second user 116 may include, but is not limited to, healthcare professional, entertainment professional, business professional, law professional, engineer, industrial professional, researcher or analyst, law enforcement, military, etc. The geo-location may include any geographical location preferred by the first user 114 or the second user 116, or where the first user 114, or the second user 116 may be present during the conversation. The time of conversation may include any preferred time by the first user 114 or the second user 116, or a time of day when the conversation may have taken place. For example, the circuitry 202 may extract the text information 110A (such as “Sushi”) based on a geo-location (such as Tokyo) of the first user 114 as the extraction criteria. In another example, the circuitry 202 may extract the text information 110A (such as “Sushi”) based on the context of the conversation based on other terms (such as “popular in Tokyo”) in the conversation. In another example, the circuitry 202 may extract the text information 110A based on the profession of the first user 114 or the second user 116 as the extraction criteria. In case the profession of the first user 114 or the second user 116 is medical, the circuitry 202 may extract medical terms (such as name of medicine, prescription amount, etc.) from the conversation. In case the profession of the first user 114 or the second user 116 is law, the circuitry 202 may extract legal terms (such as sections of the United States code) from the conversation. In another example, the circuitry 202 may extract the text information 110A (such as exam schedule, website of enrollment, etc.) in case the extraction criteria includes the relationship between the first user 114 and the second user 116 (such as student and teacher). In another example, the circuitry 202 may extract the text information 110A (such night, day, AM, PM, etc.) in case the extraction criteria includes the time of conversation.

At 306, a type of information (such as the type of information 110B) may be identified. The circuitry 202 may be configured to apply the machine learning (ML) model 110 on the extracted text information 110A to identify the at least one type of information 110B of the extracted text information 110A. The ML model 110 may input the extracted text information 110A to output the type of information 110B. The at least one type of information 110B may include, but not limited to, at least one of a location, a phone number, a name, a date, a time schedule, a landmark (for example, near XYZ store), a unique identifier (for example, an employee ID, a customer ID, etc.), a universal resource locator, or other specific categories of information. For example, the ML model 110 may input a predefined set of numbers as the text information 110A, to identify the type of information 110B as “phone number”. In an example, the type of information 110B may be associated with the location such as an address of a particular location, a preferred location (e.g. home or office), or a location of interest of the first user 114, or any other location associated with the first user 114. In another example, the type of information 110B may be associated with a phone number of another personnel, or commercial place, or any other establishment. The type of information 110B may include a combination of a name, location, or schedule, such as, the name of person that the first user 114 may intend or is required to meet at a particular location and schedule. In such a scenario, the circuitry 202 may be configured to determine the type of information 110B as a name, a location, a date, and a time (e.g. John from ABC bank, near Office, on Friday, at lunchtime). The circuitry 202 may be further configured to store the extracted text information 110A, and the type of information 110B for further processing.

At 308, a set of applications (such as the set of applications 112) may be determined. The circuitry 202 may be configured to determine the set of applications 112 associated with the electronic device 302A based on the identified at least one type of information 110B. In an embodiment, the circuitry 202 may be further configured to determine the set of applications 112 for the identified at least one type of information 110B based on the application of the ML model 110. The ML model 110 may be trained to output the set of applications 112 based on the identified type of information 110B. The set of applications 112 may include one or more applications such as the first application 112A, the second application 112B, or Nth application 112N. For each type of information 110B, the circuitry 202 may be configured to determine the set of applications 112. Example of the set of applications 112 that may be determined for the type of information 110B (e.g. John from ABC bank, near Office, on Friday, at lunchtime) may include, but are not limited to, a calendar application (to save an appointment), a phonebook (to save name and number), an e-commerce application (to make a lunch reservation), a web browser (to find restaurants near Office), a social networking application (to check John's profile or ABC bank's profile), or a notes application (to save relevant notes for the appointment). Different examples related to the set of applications 112 are provided, for example, in FIGS. 1 and 4A-4E.

At 310, a first application (such as the first application 112A) may be selected. The circuitry 202 may be configured to select the first application 112A from the determined set of applications 112 based on at least one selection criteria 310A. In an embodiment, the at least one selection criteria 310A may include at least one of a user profile associated with the first user 114, a user profile associated with the second user 116 in the conversation with the first user 114, or a relationship between the first user 114 and the second user 116. The circuitry 202 may retrieve the user profile about the first user 114 and the second user 116 from the memory 204 or from the server 106. In an example, the circuitry 202 may select the calendar application (as the first application 112A) to save the appointment with John as “meeting with John from ABC bank, near Office, on Friday, at 1 PM.”

In another example, the conversation between the first user 114, and the second user 116 may include the extracted text information 110A, such as “Let's go out this Saturday . . . ”. The circuitry 202 may identify the type of information 110B as an activity schedule using the ML model 110. Further, based on the selection criteria 310A, the circuitry 202 may be configured to select the first application 112A. In an example, the circuitry 202 may determine the relationship between the first user 114 and the second user 116 as friends. Based on the user profile associated with the first user 114, and the user profile associated with the second user 116 in the conversation, the circuitry 202 may determine activities preferred or performed by the first user 114 and the second user 116, on weekends. For example, the preferred activity for the first user 114 and the second user 116 may include trekking. The circuitry 202 may then select the first application 112A based on the selection criteria 310A (such as the relationship between the first user 114 and the second user 116, the user profile, etc.). In such a scenario, the first application 112A may include a calendar application (to set a reminder of the meeting), a web browser (to browse websites associated with nearby trekking facilities), or an e-commerce shopping application to purchase trekking gear, as shown in Table 1A. In another example, the preferred activity for the first user 114 and the second user 116 may include watching movies. The circuitry 202 may then select the first application 112A based on the selection criteria 310A (such as the relationship between the first user 114 and the second user 116, and/or the user profiles). In such a scenario, the first application 112A may include a calendar application (to set a reminder of the meeting), a web browser (to browse latest movies), or an e-commerce ticketing application (to purchase movie tickets), as shown in Table 1A.

TABLE 1A
Selection of Activity and Application based on Profile

| Extracted Text Information 110A | Profile (e.g. preferred activity or Interest) | Selected Application |
|---|---|---|
| “Let’s go out this Saturday” | Trekking | Web browser/E- commerce shopping/ Calendar application |
| “Let’s go out this Saturday” | Movies | Web Browser/E- commerce ticketing/ Calendar application |
| “Let’s go out this Saturday” | Sightseeing | Web Browser/Map/ Calendar application |

In another example, the preferred activity for the first user 114 and the second user 116 may include sightseeing. The circuitry 202 may then select the first application 112A based on the selection criteria 310A (such as the relationship between the first user 114 and the second user 116, the user profile, etc.). In such a scenario, the first application 112A may include a calendar application (to set a reminder of the meeting), a web browser (to browse nearby tourist spots), or a map application (to plan a route to nearby tourist spots), as shown in Table 1A.

TABLE 1B
Selection of Activity and Application based on Environment

| Extracted Text Information 110A | Weather Forecast | Suggested activity | Selected Application |
|---|---|---|---|
| “Let’s go out this Saturday” | Sunny, 76 degrees F | Trekking | Web browser/E- commerce shopping/ Calendar application |
| “Let’s go out this Saturday” | Chance of Rain, 60% precipitation | Movies | Web Browser/E- commerce ticketing/ Calendar application |
| “Let’s go out this Saturday” | 20 degrees F | Visit to Museum | Web Browser/Map/ Calendar application |

In another embodiment, the circuitry 202 may suggest an activity based on the environment (such the weather forecast) around the first user 114 at a time of the activity. For example, the circuitry 202 may identify the type of information 110B as an activity schedule based on the phrase “Let's go out this Saturday . . . ”. The circuitry 202 may determine the activity to be suggested based on the weather forecast at the time of the activity, in addition to the user profile of the first user 114. As shown in Table 1B, the circuitry 202 may suggest “trekking” based on the weather forecast (e.g. Sunny, 76 degrees F.) that is favorable for trekking or other outdoor activities. For example, the circuitry 202 may not suggest an outdoor activity in case the weather forecast indicates high temperatures (such as 120 degrees F.). In another example, the circuitry 202 may suggest “movies” based on the weather forecast that indicates “Chance of Rain, 60% precipitation”. In another example, the circuitry 202 may suggest another indoor activity (such as “visit to museum”) based on the weather forecast that indicates low temperatures (such as 20 degrees F.). In another embodiment, the circuitry 202 may suggest an activity based on the seasons at a particular location. For example, the circuitry 202 may suggest outdoor activities during the spring season, and may suggest an indoor activity during the winter season. In another embodiment, the circuitry 202 may further add a calendar task based on the environment condition on the day of the scheduled activity. For example, the circuitry 202 may add the calendar task such as “carry an umbrella” because there is 60% chance of precipitation on Saturday. It should be noted that data provided in Tables 1A and 1B may be merely taken as examples and may not be construed as limiting the present disclosure.

In another example, the circuitry 202 may determine the relationship between the first user 114 and the second user 116 as new colleagues. In such a scenario, the first application 112A may include a calendar application to set a reminder of the meeting or a social networking application to check the user profile of the second user 116. In an embodiment, for the same extracted text information 110A, the circuitry 202 may be configured to select a different application (as the first application 112A) based on the selection criteria 310A.

In an embodiment, the at least one selection criteria 310A may further include, but not limited to, a context of the conversation, a capability of the electronic device 302A to execute the set of applications 112, a priority of each application of the set of applications 112, a frequency of selection of each application of the set of applications 112, authentication information of the first user 114 registered by the electronic device 302A, usage information corresponding to the set of applications 112, current news, current time, a geo-location related of the electronic device 302A of the first user 114, a weather forecast, or a state of the first user 114.

The context of the conversation may include, but not limited to, a work-related conversation, a personal conversation, a bank-related conversation, conversation about an upcoming/current event, or other types of conversations. In an embodiment, the circuitry 202 may be further configured to determine the context of the conversation based on a user profile of the second user 116 in the conversation with the first user 114, a relationship of the first user 114 and the second user 116, a profession of each of the first user 114 and the second user 116, a frequency of the conversation with the second user 116, or a time of the conversation. For example, the extracted text information 110A from the conversation may include the phrase such as “. . . let's meet at 11 AM . . .”. In an example scenario, the relationship between the first user 114 and the second user 116 may be professional, and the frequency of the conversation with the second user 116 may be “often”. In such a scenario, the selected first application 112A may include a web browser or an enterprise application to book a preferred meeting room. In another scenario, the relationship between the first user 114 and the second user 116 may be personal (e.g. a friend), and the frequency of the conversation with the second user 116 may be “seldom”. In such a scenario, the selected first application 112A may include a web browser or an e-commerce application to reserve a table for brunch at a preferred restaurant based on the user profile (or relationship) associated with the first user 114 or the second user or frequency of the conversation.

The capability of the electronic device 302A to execute the first application 112A may indicate whether the electronic device 302A may execute the first application 112A at a particular time (for example, due to processing load or network connectivity). The authentication information of the first user 114 registered by the electronic device 302A may indicate whether the first user 114 is logged-in to the first application 112A and necessary permissions are granted to the first application 112A by the first user 114. The usage information corresponding to the first application 112A may indicate information associated with a frequency of usage of the first application 112A by the first user 114. For example, the frequency of selection of each application of the set of applications 112 may indicate how frequently the first user 114 may select each of the set of applications 112. Thus, based on higher frequency of past selections, a probability to select the first application 112A from the set of applications 112 may be higher.

The priority of each application of the set of applications 112 may indicate different predefined priorities for selection of an application (as the first application 112A) among the determined set of applications 112. In an embodiment, the circuitry 202 may be further configured to change the priority associated with each application of the set of applications 112 based on a relationship between the first user 114 and the second user 116. For example, a priority of the first application 112A (e.g. food ordering application) for a conversation with a personal relationship (such as a family member) may be higher compared to the priority of the first application 112A for a conversation with a professional relationship (such as a colleague). In other words, the circuitry 202 may select the first application 112A (e.g. food ordering application) among the determined set of applications 112 based on the conversation with a family member (such as, parents, spouse, or children) and select a second application 112B (e.g. an enterprise application) among the determined set of applications 112 based on the conversation with a colleague. The priority of each application of the set of applications 112 in association with the relationship between the first user 114 and the second user 116 may be predefined in the memory 204, as described, for example, in Table 2.

In an embodiment, the extracted text information 110A from the conversation may include the phrase “let's meet at 1 PM”. Based on the text information 110A and the selection criteria 310A, the circuitry 202 may be configured to select the first application 112A for execution based on context of the conversation, relationship between users, or location of the first user 114, and display the output information based on the execution of the first application 112A, as shown in Table 2:

TABLE 2
Priority of Applications cased on Relationship

| Type of information | Context/Relationship/ Location | Highest Priority Application | Output information |
|---|---|---|---|
| Time | Professional/Colleague/ | Enterprise | Meeting room |
| schedule | Office | application | booked notification |
| Time schedule | Personal/Spouse/Mall | Web Browser/ E-commerce app for | Table reservation notification |
| | | restaurant reservation | |
| Time schedule | Personal/Child/Home | Food ordering application | Meal order notification |
| Time schedule | Business/Client/Client Office | Cab aggregator application | Cab booking notification |

It should be noted that data provided in Table 2 may be merely taken as examples and may not be construed as limiting the present disclosure. In an embodiment, the look-up table (Table 2) may store an association between a task in association with the relationship between the first user 114 and the second user 116. In an example, the task associated with the extracted text information 110A for a colleague may be different compared to a task associated with the extracted text information 110A for a spouse. In another embodiment, the circuitry 202 may select the second application 112B based on a time of the meeting in the extracted text information 110A or based on the time of the conversation. For example, in case the time of the conversation is “11:00 AM”, and the meeting time is “1:00 PM”, the circuitry 202 may select the e-commerce application to reserve a table at a restaurant. In another case, in case the time of the conversation is “12:30 PM”, and the meeting time is “1:00 PM”, the circuitry 202 may alternatively or additionally select the cab aggregator application to book a cab to the meeting place.

At 312, the first application 112A may be executed. The circuitry 202 may be configured to control execution of the selected first application 112A based on the text information 110A. The execution of the first application 112A may be associated with the capability of the electronic device 302A to execute a particular application. In an example, the text information 110A may indicate a phone number, the circuitry 202 may be configured to select a phonebook application for execution, in order to save a new contact or directly call or send message to the new contact. In another example, the text information 110A may indicate a location, the circuitry 202 may be configured to select a map application for navigation to the indicated location in the extracted text information 110A. The execution of the selected first application 112A is further described, for example, in FIGS. 4A-4E.

At 314, output information may be displayed. The circuitry 202 may be configured to control display of the output information based on the execution of the first application 112A. The circuitry 202 may display the output information on the display device 212 of the electronic device 302A. Examples of the output information may include, but is not limited to, a set of instructions to execute a task, a uniform resource locator (URL) related to the text information 110A, a website related to the text information 110A, a keyword in the text information 110A, a notification of the task based on the conversation, a notification of a new contact added to a phonebook as the first application 112A, a notification of a reminder added to a calendar application as the first application 112A, or a user interface of the first application 112A. The display of output information is further described, for example, in FIGS. 4A-4E.

FIG. 4A is a diagram that illustrates an exemplary first user interface (UI) that may display output information, in accordance with an embodiment of the disclosure. FIG. 4A is explained in conjunction with elements from FIGS. 1, 2, and 3. With reference to FIG. 4A, there is shown a UI 400A. The UI 400A may display a confirmation screen 402 on a display device (such as the display device 212) for the execution of the first application 112A. The electronic device 102 may control the display device 212 to display the output information.

In an example, the extracted text information 110A from the conversation may include the phrase “let's meet at 1 PM”. Based on the text information 110A and the selection criteria 310A, the circuitry 202 may be configured to automatically select the first application 112A for execution, and display the output information based on the execution of the first application 112A. In FIG. 4A, there is further shown a UI element (such as a “Submit” button 404). In an example, the circuitry 202 may be configured to receive a user input through the “Submit” button 404. In an embodiment, the display device 212 may display the confirmation screen 402 for user confirmation of a task in case more than one first application 112A is selected for execution by the electronic device 102, as shown in FIG. 4A. The user input through the submit button 404 may be indicative of a confirmation of a task corresponding to the selected first application 112A (such as a calendar application, an e-commerce application, etc.). The UI 400A may further include a highlighting box indicative of a selection of the task, which may be moved to indicate a different selection based on user input. In FIG. 4A, the tasks corresponding to the selected first application 112A may be displayed as “Set meeting reminder”, “Book a table at restaurant”, or “Open food delivery application”. When the circuitry 202 receives the user confirmation of the selected task (via “Submit” button on the display device 212), the circuitry 202 may execute the corresponding first application 112A, and display output information, as shown in FIGS. 4D and 4E and Tables 1-5. For example, when the circuitry 202 receives the confirmation of the task “Set Meeting Reminder” corresponding to a calendar application, as shown in FIG. 4A, the circuitry 202 may execute the calendar application to set a meeting reminder and display a notification of the reminder as the output information.

FIG. 4B is a diagram that illustrates an exemplary second user interface (UI) that may display output information, in accordance with an embodiment of the disclosure. FIG. 4B is explained in conjunction with elements from FIGS. 1, 2, 3, and 4A. With reference to FIG. 4B, there is shown a UI 400B. The UI 400B may display a confirmation screen 402 on a display device (such as the display device 212) for the execution of the first application 112A. In an example, the extracted text information 110A from the conversation may include the phrase “check out this website . . . ”. Based on the text information 110A and the selection criteria 310A, the circuitry 202 may be configured to display the output information as a task to be executed by the selected first application 112A. The display device 212 may display the confirmation screen 402 for user confirmation of a task in case more than one first application 112A is selected for execution by the electronic device 102, as shown in FIG. 4B. The user input through the submit button 404 may be indicative of a confirmation of the task corresponding to the selected first application 112A (such as a browser). The UI 400B further include a highlighting box indicative of a selection of the task, which may be moved to indicate a different selection based on user input. In FIG. 4B, the task corresponding to the selected first application 112A may be displayed as “Open a URL: ‘A’ for information, “Bookmark URL ‘A’”, “Visit website: ‘B’ for information”, or “Bookmark website B”. When the circuitry 202 receives the user confirmation of the selected task (via the display device 212), the circuitry 202 may execute the corresponding first application 112A, and display output information, as shown in FIGS. 4D and 4E and Tables 1-5. For example, when the circuitry 202 receives the confirmation of the task “Visit website: ‘B’ for information” corresponding to a Browser, as shown in FIG. 4B, the circuitry 202 may execute the Browser and display the website as the output information. Examples of the tasks corresponding to the selected first application 112A based on the extracted time schedule or URL, are presented in Table 3, as follows:

TABLE 3
Exemplary of tasks corresponding to selected application

| Type of Information | Context of Conversation | Selected Application | State of User | Task/Output Information |
|---|---|---|---|---|
| Time schedule | Professional | Calendar | Stationary | Set meeting reminder |
| Time Schedule | Personal | E-commerce application | Stationary | Book table at a restaurant/Order food from food delivery application |
| URL | Professional | Browser A | Stationary | Open URL in web browser |
| | | | Driving | Bookmark URL as for later |
| URL | Casual | Browser B | Stationary | Visit website in web browser |
| | | | Driving | Bookmark website for later |

In another embodiment, the circuitry 202 may recommend a task or an action based on the environment (such as the state or situation of the first user 114) that impacts one or more actions available to the first user 114. For example, in case the first user 114 is having a conversation while driving, the circuitry 202 may extract several pieces of the text information 110A (such as, a name, a phone number, or a website) from the conversation. Based on the state of the first user 114 (such as a driving state), the circuitry 202 may present a different action or task compared to the task recommended when the first user 114 is stationary. For example, in case the circuitry 202 determines that the state of the first user 114 is “driving”, the circuitry 202 may recommend a task corresponding to the selected first application 112A such as “Bookmark URL ‘A’” or “Bookmark website ‘B’”, as shown in FIG. 4B and Table 3, so that the first user 114 may access the saved URL or website at a later point in time. The circuitry 202 may determine the user state (e.g. stationary or driving) of the first user 114 based on various methods, such as, user input on the electronic device 102 (such as “driving mode”), past user behaviour (such as morning commute to Office between 9 and 10), or varying GPS position of the electronic device 102. It should be noted that data provided in Table 3 may be merely taken as exemplary data and may not be construed as limiting the present disclosure.

FIG. 4C is a diagram that illustrates an exemplary third user interface (UI) that may display output information, in accordance with an embodiment of the disclosure. FIG. 4C is explained in conjunction with elements from FIGS. 1, 2, 3, 4A, and 4B. With reference to FIG. 4C, there is shown a UI 400C. The UI 400C may display a confirmation screen 402 on a display device (such as the display device 212) for the execution of the first application 112A. In an example, the extracted text information 110A from the conversation may include the location “. . . apartment 1234, ABC street . . .”. Based on the text information 110A and the selection criteria 310A, the circuitry 202 may be configured to control the display device 212 to display the confirmation screen 402 for user confirmation of a task in case more than one first application 112A is selected for execution by the electronic device 102, as shown in FIG. 4C. The UI 400C further include a highlighting box indicative of a selection of the task, which may be moved to indicate a different selection based on user input. In FIG. 4C, the tasks corresponding to the selected first application 112A may be displayed as “Open map application”, “Visit website: ‘B’ for location information”, and “Save address in Notes application”. When the circuitry 202 receives the user confirmation of the selected task (via the display device 212), the circuitry 202 may execute the corresponding first application 112A, and display output information, as shown in FIGS. 4D and 4E and Tables 1-5. For example, when the circuitry 202 receives the confirmation of the task “Save address in Notes application” corresponding to a Notes application, as shown in FIG. 4B, the circuitry 202 may execute the Notes application and display a notification of the saved address as the output information. Examples of the tasks corresponding to the selected first application 112A based on the extracted location, are presented in Table 4, as follows:

TABLE 4
Exemplary tasks corresponding to selected applications

| Type of information | Selected Application | Task/Output Information |
|---|---|---|
| Location | Map Application | Open/Navigate with Map Application |
| | Browser | Visit website B for location information |
| | Notes Application | Save address |

It should be noted that data provided in Table 4 may be merely taken as exemplary data and may not be construed as limiting the present disclosure. In an example, in case the geo-location of the electronic device 102 of the first user 114 is close to the address in the extracted text information 110A, the map application may be executed in order to show distance and directions to the address.

FIG. 4D is a diagram that illustrates an exemplary fourth user interface (UI) that may display output information, in accordance with an embodiment of the disclosure. FIG. 4D is explained in conjunction with elements from FIGS. 1, 2, 3, 4A, 4B, and 4C. With reference to FIG. 4D, there is shown a UI 400D. The UI 400D may display the output information on a display device (such as the display device 212), based on the execution of the first application 112A. For example, UI 400D may display a user interface of the first application 112A as the output information. In an example, the extracted text information 110A from the conversation may include “. . . phone number 1234 . . . ”. Based on the text information 110A and the selection criteria 310A, the circuitry 202 may be configured to display the output information as a user interface of a phonebook, or a notification of a new contact added to the phonebook. In FIG. 4D, the output information (e.g. the user interface of the phonebook) may be displayed as “Create contact . . . Name: ABC, and phone: 1234”. Examples of the tasks corresponding to the selected first application 112A based on the extracted phone number, are presented in Table 5, as follows:

TABLE 5
Exemplary tasks corresponding to selected applications

| Type of information | Selected Application | Task/Output Information |
|---|---|---|
| Phone number | Phonebook | Create a new contact or add in existing contact |
| Phone number | Phone | Call number |
| Phone number | Caller Identification Application | Look up phone number |

It should be noted that data provided in Table 5 for the set of instructions to execute the task may be merely taken as exemplary data and may not be construed as limiting the present disclosure. In FIG. 4D, there is further shown a UI element (such as an edit contact button 406). In an embodiment, the circuitry 202 may be configured to receive a user input through the edit contact button 406. In an example, the user input through the edit contact button 406 may allow changes to the contact information before saving to the phonebook.

FIG. 4E is diagram that illustrates an exemplary fifth user interface (UI) that may display output information, in accordance with an embodiment of the disclosure. FIG. 4E is explained in conjunction with elements from FIGS. 1, 2, 3, 4A, 4B, 4C, and 4D. With reference to FIG. 4E, there is shown a UI 400E. The UI 400E may display the output information on a display device (such as the display device 212), based on the execution of the first application 112A. For example, UI 400E may display a user interface of the first application 112A as the output information. In an embodiment, the extracted text information 110A from the conversation may include the meeting schedule“. . . meet at ABC . . . ”. Based on the text information 110A and the selection criteria 310A, the circuitry 202 may be configured to display the output information as a user interface of a calendar application (as the first application 112A), or as a notification of a reminder added to the calendar application. In FIG. 4E, the output information (e.g. the user interface of the calendar application) may be displayed as “Set reminder, Title: ABC, Time: HH:MM, Date: DD/MM/YY”. Examples of the task corresponding to the selected first application 112A based on the extracted meeting schedule, are presented in Table 6, as follows:

TABLE 6
Exemplary task corresponding to selected application

| Type of information | Relationship/ Context/Profile | Selected Application | Task/Output Information |
|---|---|---|---|
| Meeting schedule | Colleague or Client/ Professional | Email application | Send meeting invite |
| Meeting schedule | Friend/Casual | Calendar | Set a reminder |
| | | application | |

It should be noted that data provided in Table 6 for the set of instructions to execute the task may be merely taken as exemplary data and may not be construed as limiting the present disclosure. In FIG. 4E, there is further shown a UI element (such as an edit reminder button 408). In an embodiment, the circuitry 202 may be configured to receive a user input through the edit reminder button 408, which may allow edit of the reminder stored in the calendar application.

FIG. 5 is a diagram that illustrates an exemplary user interface (UI) that may recognize verbal cues as trigger to capture audio signals, in accordance with an embodiment of the disclosure. FIG. 5 is explained in conjunction with elements from FIGS. 1, 2, 3, and 4A-4E. With reference to FIG. 5, there is shown a UI 500. The UI 500 may display the verbal cues 502, to be recognized as triggers to capture the audio signals (i.e. a portion of the conversation), on a display device (such as the display device 212). The electronic device 102 may control the display device 212 to display the verbal cues 502 such as “cue 1”, “cue 2” for editing and confirmation by the first user 114. For example, “cue 1” may be set as “phone number” and “cue 2” may be set as “name” or “address”, etc. The circuitry 202 may receive a user input indicative of the verbal cue to set the verbal cue. The circuitry 202 may be configured to search the web to receive the verbal cues 502.

In an embodiment, the circuitry 202 may be further configured to recognize a verbal cue 502 (such as “cue 1” or “cue 2”) in the conversation between the first user 114 and the second user 116 as a trigger to capture the audio signal. The circuitry 202 may be configured to receive the audio signal from an audio capturing device (such as the audio capturing device 206) or from the recorded/ongoing conversation, based on the recognized verbal cue 502. In an example, the circuitry 202 may receive a verbal cue 502 to start and/ or stop retrieval of the audio signal from the audio capturing device 206 or from the ongoing conversation in a telephonic call or a video call. For example, a verbal cue “Start” may trigger capture of the audio signal corresponding to the conversation, and a verbal cue “Stop” may stop the capture of the audio signal. The circuitry 202 may then save the captured audio signal in the memory 204.

It may be noted that a person of ordinary skill in the art will understand that the verbal cues may include other suitable cues in addition to the verbal cues 502 which are illustrated in FIG. 5 to describe and explain the function and operation of the present disclosure. A detailed description for the other verbal cues 502 recognized by the electronic device 102 has been omitted from the disclosure for the sake of brevity.

In FIG. 5, there is further shown UI element (such as a “submit” button 504). In an embodiment, the circuitry 202 may be configured to receive a user input through the UI 500 and the submit button 504. In an embodiment, the user input through the UI 500 may be indicative of confirmation of the verbal cues 502 to be recognized. There is further shown a UI element (such as an edit button 506). In an embodiment, the circuitry 202 may be configured to receive a user input for modification of the verbal cues 502 through the edit button 506.

FIG. 6 is a diagram that illustrates an exemplary user interface (UI) that may receive user input as trigger to capture audio signals, in accordance with an embodiment of the disclosure. FIG. 6 is explained in conjunction with elements from FIGS. 1, 2, 3, 4A-4E, and 5. With reference to FIG. 6, there is shown a UI 600. The UI 600 may display a plurality of UI elements on a display device (such as the display device 212). There is further shown UI element (such as a phone call screen 602, a mute button 604, a keypad button 606, a recorder button 608, and a speaker button 610). In an embodiment, the circuitry 202 may be configured to receive a user input through the UI 600 and the UI elements (604, 606, 608, and 610). In an embodiment, the selection of a UI element, of the UI 600, may be indicated by a dotted rectangular box, as shown in FIG. 6.

In an embodiment, the circuitry 202 may be further configured to receive the user input indicative of a trigger to capture the audio signal corresponding to the conversation. The circuitry 202 may be further configured to receive the audio signal from an audio capturing device (such as the audio capturing device 206), or from the recorded/ongoing conversation, based on the received user input. In an example, the circuitry 202 may be configured to receive the user input by the recorder button 608. The circuitry 202 may start capturing the audio signal corresponding to the conversation based on the selection of the recorder button 608. The circuitry 202 may be configured to stop the recording of the audio signal based on another user input to the recorder button 608. The circuitry 202 may then save the recorded audio signal in the memory 204 based on the received other user input via the recorder button 608. The functionalities of the mute button 604, the keypad button 606, and the speaker button 610 are known to a person of ordinary skill in the art, and a detailed description for the mute button 604, the keypad button 606, and the speaker button 610 has been omitted from the disclosure for the sake of brevity.

FIG. 7 is a diagram that illustrates an exemplary user interface (UI) that may search extracted text information based on user input, in accordance with an embodiment of the disclosure. FIG. 7 is explained in conjunction with elements from FIGS. 1, 2, 3, 4A-4E, 5, and 6. With reference to FIG. 7, there is shown a UI 700. The UI 700 may display the captured conversation 702 on a display device (such as the display device 212). The electronic device 102 may control the display device 212 to display the captured conversation 702.

In an embodiment, the circuitry 202 may be configured to receive a user input indicative of a keyword. The circuitry 202 may be further configured to search the extracted text information 110A based on the user input, and control display of a result of the search. In FIG. 7, the conversation may be displayed as “First user: . . . I'd like to have phone installed . . . , Second user: . . . name and address, please . . . , first user: address is 1600 south avenue, apartment 16 . . . ”. There is further shown UI elements, such as, a “submit” button 704, and a search text box 706. In an embodiment, the circuitry 202 may be configured to receive a user input through the submit button 704 and the search text box 706. In an embodiment, the user input may be indicative of a keyword (for example, “address” or “number”) in the UI 700. The circuitry 202 may be configured to search the conversation for the keyword (such as “address”), extract the text information 110A (such as “address is 1600 south avenue, apartment 16”) based on the keyword, and control the execution of the first application 112A (for example, a map application) based on the extracted text information 110A. In an embodiment, the circuitry 202 may employ the result of the keyword search (as the extracted text information 110A) and the type of the result (as the type of information 110B) to further train the ML model 110, as described, for example, in FIG. 8.

FIG. 8 is a diagram that illustrates exemplary operations for training a machine learning (ML) model employed for information extraction and user-oriented actions based on audio conversation, in accordance with an embodiment of the disclosure. FIG. 8 is explained in conjunction with elements from FIGS. 1, 2, 3, 4A-4E, 5, 6, and 7. With reference to FIG. 8, there is shown a block diagram 800, that illustrates exemplary operations from 802 to 806, as described herein. The exemplary operations illustrated in block diagram 800 may start at 802 and may be performed by any computing system, apparatus, or device, such as by the electronic device 102 of FIG. 1 or the circuitry 202 of FIG. 2.

At 802, text information (such as the text information 110A) extracted from an audio signal 802A may be input to the machine learning (ML) model 110. The text information 110A may indicate training data for the ML model 110. The training data may be multimodal data and may be used to further train the machine learning (ML) model 110 on new examples of the text information 110A and their types. The training data may include, for example, an audio signal 802A, or new keywords associated with the text information 110A. For example, the training data may be associated with a plurality of keywords from the conversation, user input indicative of the keyword search of the extracted text information 110A, the type of information 110B, and the selection of the first application 112A for execution, as shown in FIG. 7.

Several input features may be generated for the ML model 110 based on the training data (which may be obtained from a database). The training data may include a variety of datapoints associated with the extraction criteria 304A, the selection criteria 310A, and other related information. For example, the training data may include datapoints related to the first user 114 such as the user profile of the first user 114, a profession of the first user 114, or a time of the conversation. Additionally, or alternatively, the training data may include datapoints related to a context of the conversation, a priority of each application of the set of applications 112, a frequency of selection of each application of the set of applications 112 by the first user 114, and usage (e.g. time duration) of each application of the set of applications 112 by the first user 114. The training data may further include datapoints related to current news, current time, or the geo-location of the first user 114.

Thereafter, the ML model 110 may be trained on the training data (for example new examples of the text information 110A and their types, on which the ML model 110 is not already trained). Before training, a set of hyperparameters may be selected based on a user input 808, for example, from a software developer or the first user 114. For example, a specific weight may be selected for each datapoint in the input feature generated from the training data. The user input 808 from the first user 114 may include the manual selection of the first application 112A, the keyword search for the extracted text information 110A, and the type of information 110B for the keyword search. The user input 808 may correspond to a class label (as the type of information 110B and the selected first application 112A) for the keyword (i.e. new text information) provided by the first user 114.

In training, several input features may be sequentially passed as inputs to the ML model 110. The ML model 110 may output several recommendations (such as a type of information 804, and a set of applications 806) based on such inputs. Once trained, the ML model 110 may select higher weights for datapoints in the input feature which may contribute more to the output recommendation than other datapoints in the input feature.

In an embodiment, the circuitry 202 may be configured to select the first application 112A based on user input, and train the machine learning (ML) model 110 based on the selected first application 112A. In such a scenario, the ML model 110 may be trained based on a priority of each application of the set of applications 112, the user profile of the first user 114, a frequency of selection of each application of the set of applications 112, or usage information corresponding to each application of the set of applications 112.

In an embodiment, the circuitry 202 may be further configured to search the extracted text information based on user input, and control display of the result of the search, as described, for example, in FIG. 7. The circuitry 202 may be further configured to train the ML model 110 to identify the at least one type of information 110B based on a type of the result. In such a scenario, the ML model 110 may be trained based on the result that may include, but is not limited to a location, a phone number, a name, a date, a time schedule, a landmark, a unique identifier, or a universal resource locator.

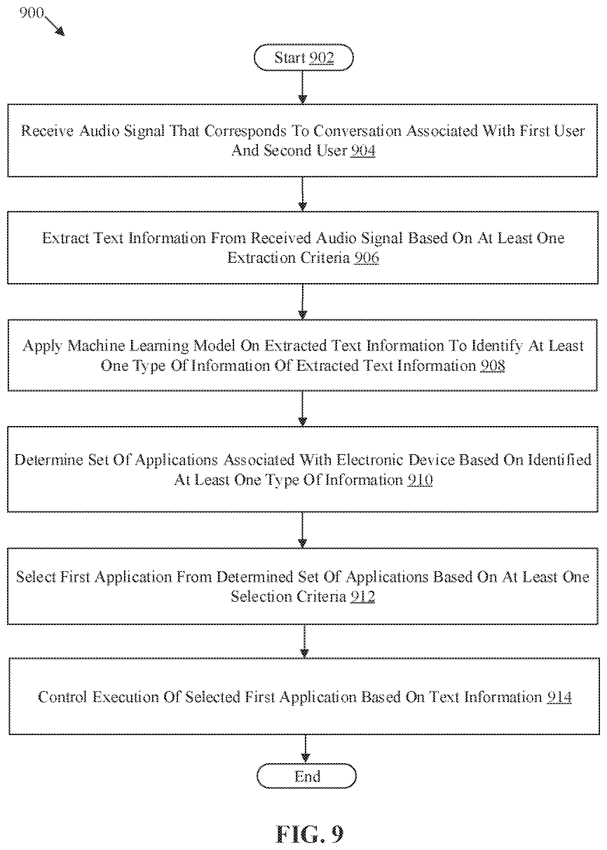

FIG. 9 depicts a flowchart that illustrates an exemplary method for information extraction and user-oriented actions based on audio conversation, in accordance with an embodiment of the disclosure. FIG. 9 is explained in conjunction with elements from FIGS. 1, 2, 3, 4A-4E, 5, 6, 7, and 8. With reference to FIG. 9, there is shown a flowchart 900. The operations of the flowchart 900 may be executed by a computing system, such as the electronic device 102, or the circuitry 202. The operations may start at 902 and proceed to 904.

At 904, an audio signal may be received. In one or more embodiments, the circuitry 202 may be configured to receive the audio signal that corresponds to a conversation (such as the conversation 702) between a first user (such as the first user 114) and a second user (such as the second user 116), as described for example, in FIG. 3 (at 302).

At 906, text information may be extracted from the received audio signal. In one or more embodiments, the circuitry 202 may be configured to extract the text information (such as the text information 110A) from the received audio signal based on at least one extraction criteria (such as the extraction criteria 304A), as described, for example, in FIG. 3 (at 304).

At 908, a machine learning model may be applied on the extracted text information 110A to identify at least one type of information. In one or more embodiments, the circuitry 202 may be configured to apply the machine learning (ML) model (such as the ML model 110) on the extracted text information 110A to identify at least one type of information (such as the type of information 110B) of the extracted text information 110A, as described, for example, in FIG. 3 (at 306).

At 910, a set of applications associated with the electronic device 102 may be determined based on the identified at least one type of information 110B. In one or more embodiments, the circuitry 202 may be configured to determine the set of applications (such as the set of applications 112) associated with the electronic device 102 based on the identified at least one type of information 110B, as described, for example, in FIG. 3 (at 308),In some embodiments, the trained ML model 110 may be applied to the identified type of information 110B to determine the set of applications 112.

At 912, a first application may be selected from the determined set of applications 112. In one or more embodiments, the circuitry 202 may be configured to select the first application (such as the first application 112A) from the determined set of applications 112 based on at least one selection criteria (such as the selection criteria 310A), as described, for example, in FIG. 3 (at 310).

At 914, execution of the selected first application 112A may be controlled. In one or more embodiments, the circuitry 202 may be configured to control of execution of the selected first application 112A based on the text information 110A, as described, for example, in FIG. 3 (at 312). Control may pass to end.

Although the flowchart 900 is illustrated as discrete operations, such as 904, 906, 908, 910, 912, and 914, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, instructions executable by a machine and/or a computer (for example the electronic device 102). The instructions may cause the machine and/or computer (for example the electronic device 102) to perform operations that include reception of an audio signal that may correspond to a conversation (such as the conversation 702) associated with a first user (such as the first user 114) and a second user (such as the second user 116). The operations may further include extraction of text information (such as the text information 110A) from the received audio signal based on at least one extraction criteria (such as the extraction criteria 304A). The operations may further include application of a machine learning model (such as the ML model 110) on the extracted text information 110A to identify at least one type of information (such as the type of information 110B) of the extracted text information 110A. The operations may further include determination of a set of applications (such as the set of applications 112) associated with the electronic device 102 based on the identified at least one type of information 110B. The operations may further include selection of a first application (such as the first application 112A) from the determined set of applications 112 based on at least one selection criteria (such as the selection criteria 310A). The operations may further include control of execution of the selected first application 112A based on the text information 110A.

Exemplary aspects of the disclosure may include an electronic device (such as, the electronic device 102) that may include circuitry (such as, the circuitry 202). The circuitry 202 may be configured to receive an audio signal that corresponds to a conversation (such as the conversation 702) associated with a first user (such as the first user 114) and a second user (such as the second user 116). The circuitry 202 may be configured to extract text information (such as the extracted text information 110A) from the received audio signal based on at least one extraction criteria (such as the extraction criteria 304A). The circuitry 202 may be configured to apply a machine learning model (such as the ML model 110) on the extracted text information 110A to identify at least one type of information (such as the type of information 110B) of the extracted text information 110A. Based on the identified at least one type of information 110B, the circuitry 202 may be configured to determine a set of applications (such as the set of applications 112) associated with the electronic device 102. The circuitry 202 may be further configured to select a first application (such as the first application 112A) from the determined set of applications 112 based on at least one selection criteria (such as the selection criteria 310A). The circuitry 202 may be further configured to control execution of the selected first application 112A based on the text information 110A.

In accordance with an embodiment, the circuitry 202 may be further configured to control display of output information based on the execution of the first application 112A. The output information may include at least one of a set of instructions to execute a task, a uniform resource locator (URL) related to the text information, a website related to the text information, a keyword in the text information, a notification of the task based on the conversation 702, a notification of a new contact added to a phonebook as the first application 112A, a notification of a reminder added to a calendar application as the first application 112A, or a user interface of the first application 112A.

In accordance with an embodiment, the at least one selection criteria 310A may include at least one of a user profile associated with the first user 114, a user profile associated with the second user 116 in the conversation 702 with the first user 114, or a relationship between the first user 114 and the second user 116. The user profile of the first user 114 may correspond to one of interests or preferences associated with the first user 114, and the user profile of the second user 116 may correspond to one of interests or preferences associated with the second user 116.

In accordance with an embodiment, the at least one selection criteria 310A may include at least one of a context of the conversation 702, a capability of the electronic device 102 to execute the set of applications 112, a priority of each application of the set of applications 112, a frequency of selection of each application of the set of applications 112, authentication information of the first user 114 registered by the electronic device 102, usage information corresponding to the set of applications 112, current news, current time, or a geo-location related of the electronic device 102 of the first user 114, a weather forecast, or a state of the first user 114.

In accordance with an embodiment, the circuitry 202 may be further configured to determine the context of the conversation 702 based on a user profile of the second user 116 in the conversation 702 with the first user 114, a relationship of the first user 114 and the second user 116, a profession of each of the first user 114 and the second user 116, a frequency of the conversation with the second user 116, or a time of the conversation 702.

In accordance with an embodiment, the circuitry 202 may be further configured to change the priority associated with each application of the set of applications 112 based on a relationship of the first user 114 and the second user 116.

In accordance with an embodiment, the audio signal may include at least one of a recorded message or a real-time conversation 702 between the first user 114 and the second user 116.

In accordance with an embodiment, the circuitry 202 may be further configured to receive a user input (such as the user input 808) indicative of a trigger to capture the audio signal associated with the conversation 702. Based on the received user input 808, the circuitry 202 may be further configured to receive the audio signal from an audio capturing device (such as the audio capturing device 206).

In accordance with an embodiment, the circuitry 202 may be further configured to recognize a verbal cue (such as the verbal cue 502) in the conversation 702 as a trigger to capture the audio signal associated with the conversation 702. Based on the recognized verbal cue 502, the circuitry 202 may be further configured to receive the audio signal from an audio capturing device (such as the audio capturing device 206).

In accordance with an embodiment, the circuitry 202 may be further configured to determine the set of applications 112 for the identified at least one type of information 110B based on the application of the machine learning (ML) model 110.

In accordance with an embodiment, the circuitry 202 may be further configured to select the first application 112A based on a user input (such as the user input 808). Based on the selected first application 112A, the circuitry 202 may be further configured to train the machine learning (ML) model 110.

In accordance with an embodiment, the circuitry 202 may be further configured to search the extracted text information 110A based on the user input 808, and control display of a result of the search. Based on a type of the result, the circuitry 202 may be further configured to train the machine learning (ML) model 110 to identify the at least one type of information 110B.

In accordance with an embodiment, the at least one type of information 110B may include at least one of a location, a phone number, a name, a date, a time schedule, a landmark, a unique identifier, or a universal resource locator.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

1. An electronic device, comprising:
circuitry configured to:
receive an audio signal that corresponds to a conversation associated with a first user and a second user;
extract text information from the received audio signal based on at least one extraction criteria;
apply a machine learning model on the extracted text information to identify at least one type of information of the extracted text information;
determine a set of applications associated with the electronic device based on the identified at least one type of information;
select a first application from the determined set of applications based on at least one selection criteria; and
control execution of the selected first application based on the text information.

2. The electronic device according to claim 1, wherein
the circuitry is further configured to control display of output information based on the execution of the first application, and
the output information comprises at least one of a set of instructions to execute a task, a uniform resource locator (URL) related to the text information, a website related to the text information, a keyword in the text information, a notification of the task based on the conversation, a notification of a new contact added to a phonebook as the first application, a notification of a reminder added to a calendar application as the first application, or a user interface of the first application.

3. The electronic device according to claim 1, wherein
the at least one selection criteria comprises at least one of a user profile associated with the first user, a user profile associated with the second user in the conversation with the first user, or a relationship between the first user and the second user,
the at least one extraction criteria comprises at least one of the user profile associated with the first user, the user profile associated with the second user in the conversation with the first user, a geo-location of the first user, or a current time,
the user profile of the first user corresponds to one of interests or preferences associated with the first user, and
the user profile of the second user corresponds to one of interests or preferences associated with the second user.

4. The electronic device according to claim 1, wherein the at least one selection criteria comprises at least one of a context of the conversation, a capability of the electronic device to execute the set of applications, a priority of each application of the set of applications, a frequency of selection of each application of the set of applications, authentication information of the first user registered by the electronic device, usage information corresponding to the set of applications, current news, current time, a geo-location of the electronic device of the first user, a weather forecast, or a state of the first user.

5. The electronic device according to claim 4, wherein the circuitry is further configured to determine the context of the conversation based on a user profile of the second user in the conversation with the first user, a relationship of the first user and the second user, a profession of each of the first user and the second user, a frequency of the conversation with the second user, or a time of the conversation.

6. The electronic device according to claim 4, wherein the circuitry is further configured to change the priority associated with each application of the set of applications based on a relationship of the first user and the second user.

7. The electronic device according to claim 1, wherein the audio signal comprises at least one of a recorded message or a real-time conversation between the first user and the second user.

8. The electronic device according to claim 1, wherein the circuitry is further configured to:
receive a user input indicative of a trigger to capture the audio signal associated with the conversation; and
receive the audio signal from an audio capturing device based on the received user input.

9. The electronic device according to claim 1, wherein the circuitry is further configured to:
recognize a verbal cue in the conversation as a trigger to capture the audio signal associated with the conversation; and
receive the audio signal from an audio capturing device based on the recognized verbal cue.

10. The electronic device according to claim 1, wherein the circuitry is further configured to determine the set of applications for the identified at least one type of information based on the application of the machine learning model.

11. The electronic device according to claim 1, wherein the circuitry is further configured to:
select the first application based on a user input; and
train the machine learning model based on the selected first application.

12. The electronic device according to claim 1, wherein the circuitry is further configured to:
search the extracted text information based on a user input;
control display of a result of the search; and
train the machine learning model to identify the at least one type of information based on a type of the result.

13. The electronic device according to claim 1, wherein the at least one type of information comprises at least one of a location, a phone number, a name, a date, a time schedule, a landmark, a unique identifier, or a universal resource locator.

14. A method, comprising:
in an electronic device:
receiving an audio signal that corresponds to a conversation associated with a first user and a second user;
extracting text information from the received audio signal based on at least one extraction criteria;
applying a machine learning model on the extracted text information to identify at least one type of information in the extracted text information;
determining a set of applications associated with the electronic device based on the identified at least one type of information;
selecting a first application from the determined set of applications based on at least one selection criteria; and
controlling execution of the selected first application based on the text information.

15. The method according to claim 14, further comprising controlling display of output information based on the execution of the first application, and
the output information comprises at least one of a set of instructions to execute a task, a uniform resource locator (URL) related to the text information, a website related to the text information, a keyword in the text information, a notification of the task based on the conversation, a notification of a new contact added to a phonebook as the first application, a notification of a reminder added to a calendar application as the first application, or a user interface of the first application.

16. The method according to claim 14, wherein
the at least one selection criteria comprises at least one of a user profile associated with the first user, a user profile associated with the second user in the conversation with the first user, or a relationship between the first user and the second user,
the at least one extraction criteria comprises at least one of the user profile associated with the first user, the user profile associated with the second user in the conversation with the first user, a geo-location of the first user, or a current time,
the user profile of the first user corresponds to one of interests or preferences associated with the first user, and
the user profile of the second user corresponds to one of interests or preferences associated with the second user.

17. The method according to claim 14, wherein the at least one selection criteria comprises at least one of a context of the conversation, a capability of the electronic device to execute the set of applications, a priority of each application of the set of applications, a frequency of selection of each application of the set of applications, authentication information of the first user registered by the electronic device, usage information corresponding to the set of applications, current news, current time, geo-location of the electronic device of the first user, a weather forecast, or a state of the first user.

18. The method according to claim 17, further comprising determining the context of the conversation based on a user profile of the second user in the conversation with the first user, a relationship of the first user and the second user, a profession of each of the first user and the second user, a frequency of the conversation with the second user, or a time of the conversation.

19. The method according to claim 17, further comprising changing the priority associated with each application of the set of applications based on the second user in the conversation with the first user.

20. A non-transitory computer-readable medium having stored thereon, computer-executable instructions that when executed by an electronic device, causes the electronic device to execute operations, the operations comprising:
receiving an audio signal that corresponds to a conversation associated with a first user and a second user;
extracting text information from the received audio signal based on at least one extraction criteria;
applying a machine learning model on the extracted text information to identify at least one type of information in the extracted text information;
determining a set of applications associated with the electronic device based on the identified at least one type of information;
selecting a first application from the determined set of applications based on at least one selection criteria; and
controlling execution of the selected first application based on the text information.
